(19) United States
(12) Patent Application Publication
(10) Pub. No.: US 2025/0156991 A1
(43) Pub. Date: May 15, 2025

(54) MULTI-FRAME IMAGE AND VIDEO RESAMPLING

(71) Applicants: Disney Enterprises, Inc., Burbank, CA (US); ETH Zürich (Eidgenössische Technische Hochschule Zürich), Zürich (CH)

(72) Inventors: Abdelaziz Djelouah, Zurich (CH); Michael Yves Bernasconi, Valendas (CH); Christopher Richard Schroers, Uster (CH)

(73) Assignees: Disney Enterprises, Inc., Burbank, CA (US); ETH Zürich (Eidgenössische Technische Hochschule Zürich), Zürich (CH)

(21) Appl. No.: 18/947,255

(22) Filed: Nov. 14, 2024

Related U.S. Application Data
(60) Provisional application No. 63/599,540, filed on Nov. 15, 2023.

(51) Int. Cl. G06T 3/40; G06V 10/44

(52) U.S. Cl. CPC G06T 3/40; G06V 10/44

(57) ABSTRACT

In some embodiments, a method determines an anchor image and a first mapping of a grid to the anchor image. The anchor image includes a first value of a characteristic and the grid includes a second value. Input images and second mappings between respective input images and the anchor image is determined. The method determines a query value for the grid based on features extracted from a location in the anchor image that is determined from the first mapping of the grid. Keys and values for each of the input images is determined based on respective input images and respective second mappings. The method weights values of the input images based on comparing the query value and the respective keys to generate weighted values. The weighted values are used to generate a feature value in a feature map. The method generates an output image from the feature map.

### CROSS REFERENCE TO RELATED APPLICATIONS

Pursuant to 35 U.S.C. § 119(e), this application is entitled to and claims the benefit of the filing date of U.S. Provisional App. No. 63/599,540 filed Nov. 15, 2023, entitled “MULTI-FRAME IMAGE AND VIDEO RESAMPLING”, the content of which is incorporated herein by reference in its entirety for all purposes.

### BACKGROUND

Increasing the resolution of images and frames is a common problem in media production, and this continues to be a problem despite better and better cameras that are capable of capturing high quality video. This is due to several reasons: keeping the video processing pipeline in lower resolution for compute and storage reasons, change of framing due to artistic considerations, or even bad capture conditions (low light, incorrect camera setting, etc.). In addition to this, enhancing a legacy low quality video catalog to meet modern standards is required in some applications.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for processing images according to some embodiments.

FIG. 2 depicts a simplified flowchart of a method for performing a resampling process according to some embodiments.

FIG. 3 depicts a more detailed example of a video processing system according to some embodiments.

FIG. 4 depicts a more detailed example of generating the key-value pairs according to some embodiments.

FIG. 5 depicts an example of performing the multi-frame attention process according to some embodiments.

FIG. 6 illustrates one example of a computing device according to some embodiments.

### DETAILED DESCRIPTION

Described herein are techniques for an image processing system. In the following description, for purposes of explanation, numerous examples and specific details are set forth to provide a thorough understanding of some embodiments. In some embodiments as defined by the claims may include some or all the features in these examples alone or in combination with other features described below, and may further include modifications and equivalents of the features and concepts described herein.

### System Overview

In some embodiments, a system provides a multi-frame resampling process that can use different types of input images to resample an anchor image. Given a first image (e.g., an anchor image the system uses an arbitrary number of additional input images to resample the anchor image to produce an output image. The resampling may transform a characteristic of the anchor image to generate the output image, such as resampling a low resolution image to an optimal higher or super-resolution result. The resampling may transform other characteristics, such as noise, artifacts, image rotation and warping, image alignment, image conversion (e.g., blurring, filtering, etc.). Resolution may be discussed, but other characteristics may be resampled. Samples from each input image may be aligned to the anchor image using mappings. The samples may also weighted and aggregated based on a relevance to the anchor image. The weighted samples may be determined using multi-frame attention that determines which samples of the input images are optimal for performing the resampling. The aggregated samples form a feature map, which is input into a prediction network to produce an output image. The process is not limited to upscaling and is also applicable to tasks where high resolution images are available, such as improving video quality from a set of high quality reference still images.

Video super resolution methods upsample an image, and commonly leverage the information from multiple input images to help produce better upscaling results. However, the methods are often limited to neighboring frames in a video and are not able to handle generic geometric transforms. Also, prior methods may have been proposed for video super-resolution; however, due to their choices in the architecture, they are limited to fixed scaling factors or even a limited number of frames. The present process supports arbitrary geometric transforms such as non-uniform scaling, rotation, and projective transforms between the input images and the anchor images, and arbitrary selection of input images.

In some embodiments, the system solves the even more general problem of multi-frame-resampling. The system may not assume any specific relationship between the frames used for resampling, and sets the problem in a generic form. For example, the system assumes that it is given an anchor image (e.g., in low resolution) and an arbitrary number of input images, and does not require the input images to have the same properties, such as the same size, resolution, or type as the anchor image. The size may be different pixel dimensions and the resolutions may be the pixel density. This allows the system to flexibly use information from different sources to resample the anchor image, and allows a wider range of applications. For example, input images are not limited to a small number of adjacent images in a video to the anchor image. In some embodiments, the input images may be adjacent to the anchor image, 10 frames away, 25 frames away, or include stand-alone mages that are not from frames of the video.

The system provides advantages in it allows a wide range of geometric transforms and an arbitrary number of input frames during the resampling (such as providing a high resolution image to upscale a video). The system can take advantage of frames further away temporally, such as the one or more neighboring frames to the anchor image, or frames that are further away from a neighboring frame (frames that are a few frames away). Also, the process extends upscaling to non-integer scaling.

In some embodiments, the system receives the anchor image, a set of query locations, a set of input images, a mapping from each input image to the anchor image, and a mapping from the anchor image to each input image. The mappings may be estimated based on different methods, such as optical flow methods, but other methods may be used. The system generates keys and values for the input images using the mappings. The keys and values may be for each pixel location of the anchor image. Also, features are extracted from the anchor image, and a query vector for each pixel of the output image is generated. The system uses a query vector to weight values based on a similarity between the query vector and the keys. An output is a feature vector for each query vector, which forms a feature map. The feature map is then converted to an output image using a prediction network.

### System

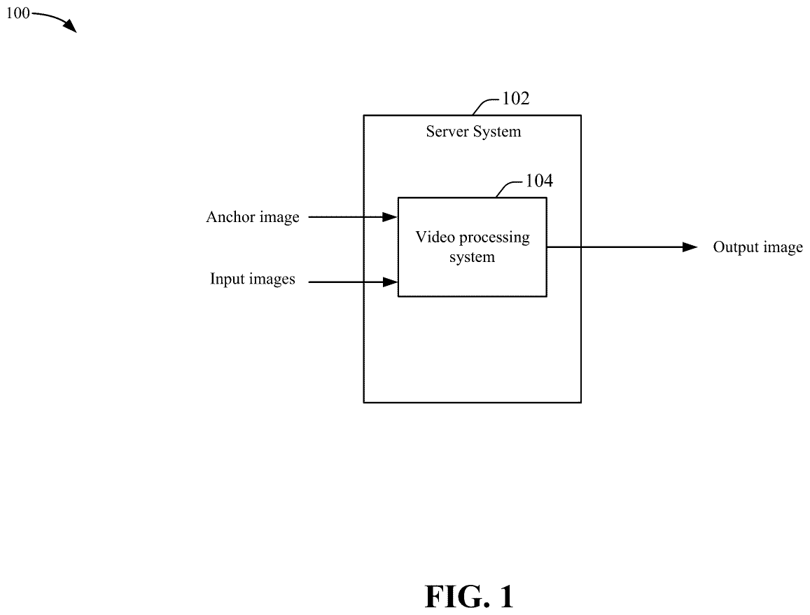

FIG. 1 depicts a simplified system 100 for processing images according to some embodiments. In some embodiments, a server system 102 may process images from a video, but server system 102 may process any type of images. In the description, an anchor image may be used interchangeably with anchor frames and input images with input frames. When discussing videos, frames may be used, which may be images from the video.

A video processing system 104 receives an anchor image and input images. Video processing system 104 may resample a characteristic of the anchor image (e.g., increase the resolution or decrease the resolution) using the input images to generate an output image. In some embodiments, the anchor image may be an image of a video that is to be upsampled to a higher resolution. The input images may be arbitrary images that are used by video processing system 104 to perform the upsampling. In some embodiments, the input images may be from the same video as the anchor image, such as frames before or after the anchor image. There is no requirement that the input images be adjacent to the anchor image. In some embodiments, some of the input images may be adjacent to the anchor image, but some input images may be a number of frames away, such as 10 frames away, 25 frames away, etc. Here, adjacent frames may be consecutive frames next to the anchor image in the video, and non-adjacent frames may be frames in which there is at least one frame between the input image and the anchor image that is not included in the input images. Also, the input images may be still images that may not be frames from the video, such as images taken during the filming process, which may be high resolution images.

The structure of video processing system 104 allows for arbitrary input images to be used. Arbitrary may mean that there are not restrictions on which type of input images may be used other than a mapping between the input image and the anchor image is provided and used to perform the upsampling. The mapping may map pixels in respective input images to corresponding pixels in the anchor image. The mapping between pixels of the input images and the anchor frame may be a correspondence or transformation that defines how pixels from the input images relate to pixels in the anchor image. The mapping may include changes in position, intensity, color, geometric transforms, and describes changes between the input image and the anchor image. The mapping may be determined using optical flow or other methods.

The process provides many advantages. For example, the use of arbitrary input images allows flexibility in the process to perform the resampling process. Additionally, the resampling process, as will be described in more detail below, may improve the output image. For example, different scaling factors may be used in the input images instead of requiring a single scaling factor, which allows different aspects of information to be extracted from the input images making the available information for resampling more robust. Additionally, using additional input images without a restriction of being a couple adjacent frames to the anchor frame in the video may also improve the output image by providing more robust information for resampling. The flexibility allows for additional information to be considered when generating the output image.

The following will now describe the overall resampling process.

### Resampling Process

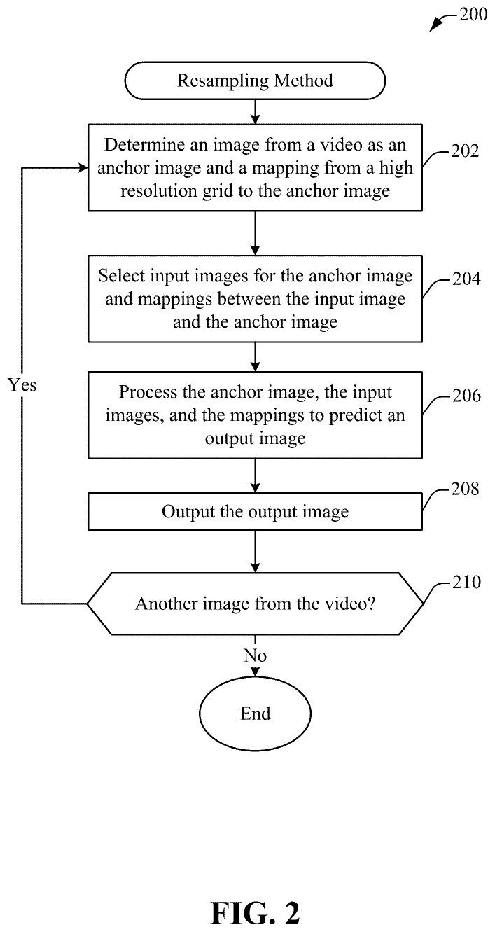

FIG. 2 depicts a simplified flowchart 200 of a method for performing a resampling process according to some embodiments. In some embodiments, video processing system 104 may be resampling frames of a video. For example, the resampling may be upsampling the frames of a video to a higher resolution. However, although upscaling is described, other resampling may performed, such as downsampling the frames, or transforming other characteristics. At 202, video processing system 104 determines an image from a video as an anchor image and a mapping from a high resolution grid to the anchor image. The high resolution grid may be a grid of pixels that correspond to the resolution of the output image, which is referred to as a “high” resolution grid in this example because upsampling may be performed. If resampling is for another characteristic, the grid may be associated with the characteristic and may not be a high resolution grid. A mapping from the high resolution grid to the anchor image may map pixels (e.g., locations) in a grid for the high resolution output image to pixels (e.g., locations) of the anchor image. The mapping may align pixels from the anchor image to corresponding pixels in the high resolution grid based on a transformation or relationship between the pixels. For example, optical flow or other image mapping processes may be used to transform the pixels in the mapping to different coordinates.

At 204, video processing system 104 selects input images for the anchor image and mappings between the input image and the anchor image. The input images may be arbitrary images, such as adjacent frames to the anchor image, but other frames may be used, such as frames that are X number of frames away from the anchor image (e.g., non-adjacent frames that are 10 frames, 25 frames, etc. away from the anchor image). Additionally, other input images may be used, such as any available high resolution images, low resolution images, or other images. Also, the input images may be different resolutions, scales, etc., and there is not a limit on the resolutions that are used.

The mappings may be a forward mapping and a backward mapping. The forward mapping may map pixels in the input image to pixels the anchor image, and the backward mapping may map pixels in the anchor image to pixels in the input image. The mappings may be generated similarly to the mapping between the anchor image and the high resolution grid, such as by using optical flow.

At 206, video processing system 104 processes the anchor image, the input image, and the mappings to predict an output image. The output image may be an upscaled image of the anchor image that is based on the input images and the mappings. The processing will be described in more detail below. At 208, video processing system 104 outputs the output image.

At 210, video processing system 104 determines if another image from the video should be processed. If so, the process reiterates to 202, where another image is determined from the video as a new anchor image. Other input images for the new anchor image may also be determined and used to resample the new anchor image. If there is not another anchor image to process (e.g., the frames of the video have all been processed), the resampling process ends.

The following will now describe video processing system 104 in more detail.

### Video Processing System

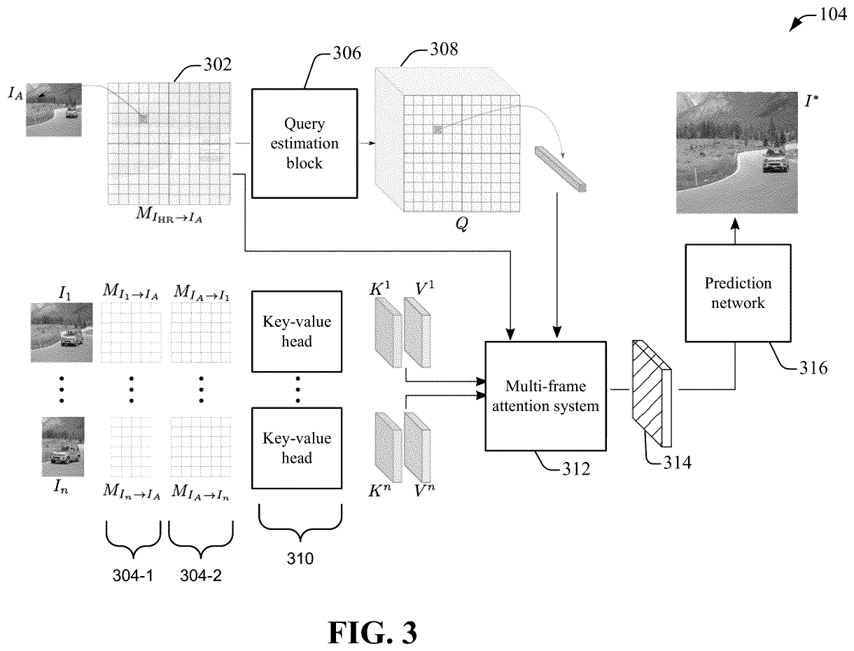

FIG. 3 depicts a more detailed example of video processing system 104 according to some embodiments. An anchor image I_{A}, is received at video processing system 104. Additionally, a mapping

$${M}_{{I}_{HR \to {I}_{A}}} 302$$

from a high-resolution grid to the anchor image is received. The high-resolution grid maps pixels from the high-resolution grid to pixels in the anchor image, such as from a location in the high resolution grid to a location in the anchor image. As shown as an example, a location in the high resolution grid is mapping to a location in the anchor image.

Video processing system additionally receives input images I₁ to Iₙ. Also, forward mappings

$${M}_{{I}_{i \to {I}_{A}}} 304 - 1$$

and backward mappings

$${M}_{{I}_{A \to {I}_{i}}} 304 - 2$$

are received for the input images. Forward mappings

$${M}_{{I}_{i \to {I}_{A}}} 304 - 1$$

map an input image to the anchor image for respective input images. Also, backward mappings

$${M}_{{I}_{A \to {I}_{i}}} 304 - 2$$

map the anchor image to the input image for respective input images. For example, forward mapping

$${M}_{{I}_{i \to {I}_{A}}} 304 - 1$$

maps pixels (e.g., locations) in the input image to pixels in the anchor image and backward mapping

$${M}_{{I}_{A \to {I}_{i}}} 304 - 2$$

maps pixels (e.g., locations) from the anchor image to the input image.

The input images may have arbitrary spatial dimensions. For example, one input image may have a first resolution or size and a second input image may have a second resolution or size. The resolutions of the input images do not need to be the same, or be the same as the anchor image or high resolution grid. The input images may also have other characteristics.

A query estimation block 306 may extract features from the anchor image. The features may be pixel values, such as color values, but other feature values may be extracted. Query estimation block 306 receives the feature values from the anchor image and mapping

$${M}_{{I}_{HR \to {I}_{A}}} 302$$

as input and produces a query vector for each output pixel in a query map 308 that is the resolution of the high resolution grid using mapping

$${M}_{{I}_{HR \to {I}_{A}}} 302.$$

For example, features are extracted from the anchor image. Then, every coordinate (X,Y) in the high resolution grid is mapped according to the mapping

$${M}_{{I}_{HR \to {I}_{A}}} 302 ,$$

and rounded to a closest coordinate in the anchor image. The difference between the real coordinates and the rounded ones may be a sampling offset. To compute the query vector, for every pixel of the output in the high resolution grid, query estimation block 306 may extract a patch of features (e.g., 3×3 pixels) from the features at the rounded location. The feature values from the feature patch and the two dimensional offset between the anchor image and the high resolution grid may be concatenated and passed to a prediction network to compute a query vector for the location in the high resolution grid. The query vector may be values that represent the extracted features. This process may be performed for each pixel of the high resolution grid. Other processes for determining the query vector may also be appreciated.

A key-value head 310 computes key-value pairs using the input images and mapping

$${M}_{{I}_{i \to {I}_{A}}} 304 - 1$$

and mapping

$${M}_{{I}_{A \to {I}_{i}}} 304 - 2.$$

The key-value head 310 takes as input an image Iᵢ and a respective mapping

$${M}_{{I}_{i \to {I}_{A}}} 304 - 1$$

and a respective mapping

$${M}_{{I}_{A \to {I}_{i}}} 304 - 2$$

for the input image, and produces a key-value pair for each pixel in the anchor image. The keys may reference pixel locations in the input image that map to locations in the anchor image via offsets. The value in the key-value pair may be a pixel value, such as a red green blue (RGB) pixel color value from the input image that will be used to upsample a location in the anchor image. The key-value pairs are calculated for each input image and every pixel of the anchor image. The key-value pairs may then be warped using mapping

$${M}_{{I}_{HR \to {I}_{A}}} 302$$

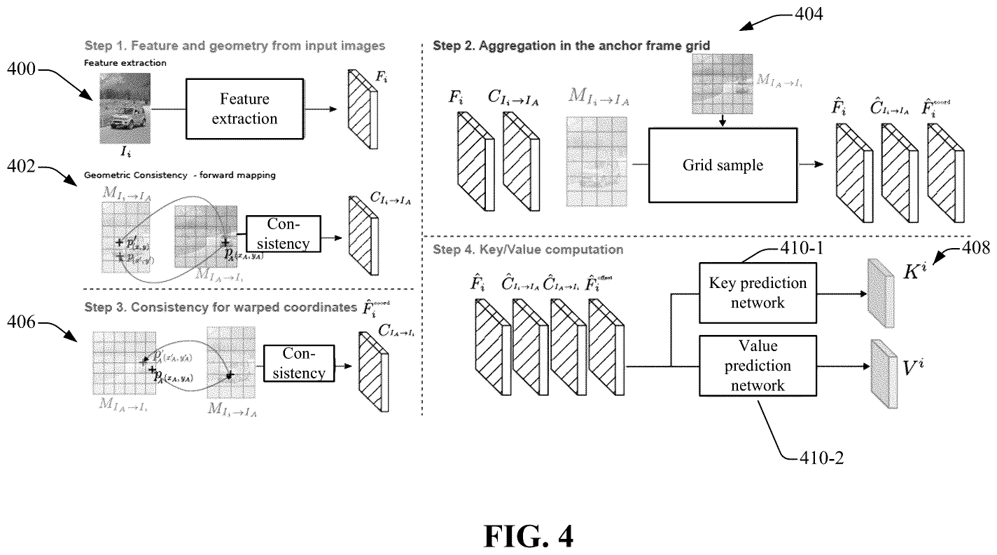

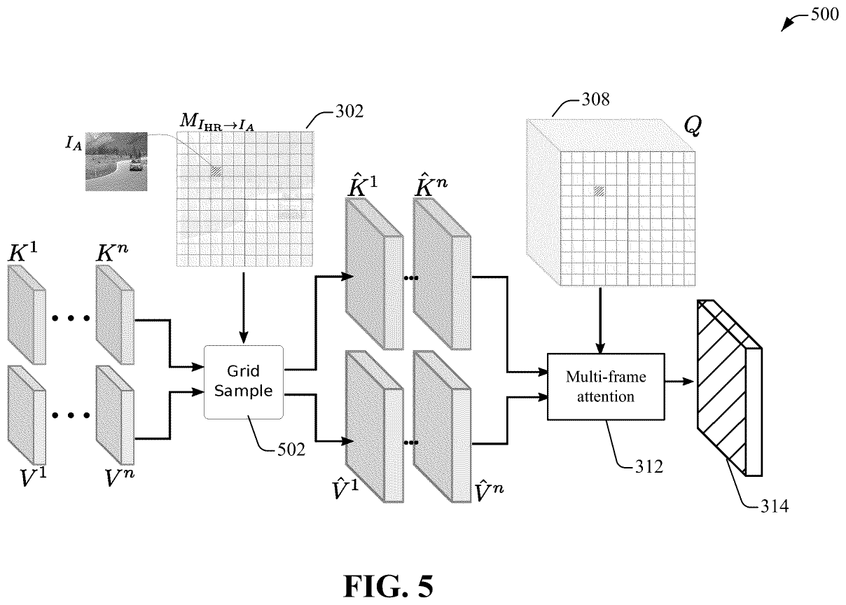

to generate key-value pairs for pixels of the output image. The process of generating the key-value pairs is described in more detail in FIGS. 4 and 5.

A multi-frame attention system 312 receives the query vector, the anchor image, mapping

$${M}_{{I}_{HR \to {I}_{A}}} 302 ,$$

and the key-value pairs from the input images. Multi-frame attention system 312 generates a fixed size feature vector for the query vector. In some embodiments, multi-frame attention system 312 may use the query vector to search keys to determine a similarity of keys from the key-value pairs to the query vector. Keys that are more similar may have respective values that are weighted higher. Conversely, keys that are less similar to the query vector may have respective values that are weighted lower. The weighted values are then combined to generate the feature vector for the query vector. The keys that are searched may be all the keys or a limited patch of keys, such as keys from around the location of the query vector. This process may be repeated for query vectors for every output pixel in the output image to form a feature map 314. In some examples, keys might describe (numerically) how sharp the corresponding image patch is or if it is well aligned with the query. The values are the features that contain the information that will later be transformed into the pixel colors. The keys with values well aligned with the query may have values weighted higher, and keys with values less aligned with the query may have values weighted lower.

Feature map 314 is input into a prediction network 316 that generates an output image. Prediction network 316 is configured to receive a feature map and generate an output image based on the values of the feature map. Different prediction networks may be used. Prediction network 316 is trained in a supervised manner using anchor images and output images. The parameters of prediction network 316 are trained based on the differences between the predicted output image and the ground truth of the output image. The process of processing the anchor image, input images, mapping

$${M}_{{I}_{HR \to {I}_{A}}} 302 ,$$

mapping

$${M}_{{I}_{i \to {I}_{A}}} 304 - 1 ,$$

and mapping

$${M}_{{I}_{A \to {I}_{i}}} 304 - 2$$

is performed to predict an output image. The output image is compared to the ground truth of the output image. The differences are then used to train the parameters of prediction network 316 to receive feature map 314 and generate a predicted output image that is closer to the ground truth of the output image. Also, training of parameters for any of query estimation block 306, key-value head 310, or multi-frame attention system 312 may be performed in addition to training of prediction network 316. Components may also be pre-trained.

The key-value pairs calculation will now be described in more detail.

### Key-Value Pair Generation

FIG. 4 depicts a more detailed example of generating the key-value pairs according to some embodiments. At 400, feature extraction is performed to extract features from the input image Iᵢ into features Fᵢ. Different features may be extracted, such as color values of pixels. The features may be included in a feature map Fᵢ that includes feature values for pixels on the input image Iᵢ. Feature extraction also adds an additional channel that indicates the scale of the input image Iᵢ to the anchor image.

At 402, a geometric consistency is calculated between a forward mapping

$${M}_{{I}_{i \to {I}_{A}}}$$

from the input image to the anchor image and a backward mapping

$${M}_{{I}_{A \to {I}_{i}}}$$

from the anchor image to the input image. This results in a forward mapping consistency

$${C}_{{I}_{i \to {I}_{A}}}$$

that measures how consistent the forward mapping

$${M}_{{I}_{i \to {I}_{A}}}$$

and the backward mapping

$${M}_{{I}_{A \to {I}_{i}}}$$

for each pixel in the input image Iᵢ. The forward mapping consistency for a pixel p at (x, y) in the input image may be computed as follows: pixel p is projected to a pixel in the anchor image using mapping

$${M}_{{I}_{i \to {I}_{A}}} .$$

The resulting projection is referred to as from pixel p′(x,y) in the input image Iᵢ to a pixel p_{A} with coordinates (x_{A}, y_{A}) in the anchor image I_{A}. Pixel p_{A} is then projected back to the input image to a pixel p(x′, y′) by interpolating mapping

$${M}_{{I}_{A \to {I}_{i}}}$$

at coordinates (x_{A}, y_{A}), such as using by bi-linearly interpolation. This is the backward projection p′ into the input image that has coordinate (x′, y′). The consistency

$${C}_{{I}_{i \to {I}_{A}}}$$

is computed based on the differences in locations, such as using e^{-|(x,y)-(x′,y′)|}, where “e” is an exponential function that may measure the difference between the forward projection and the backward projection locations.

At 404, the extracted features Fᵢ, consistency

$${C}_{{I}_{i \to {I}_{A}}} ,$$

and mapping

$${M}_{{I}_{i \to {I}_{A}}}$$

are processed with a mapping from the anchor image to the input image

$${M}_{{I}_{A \to {I}_{i}}}$$

using a grid sample, such as an interpolation (e.g., warping). The grid sample may be a nearest neighbor interpolation that warps the feature values and consistency values. This generates, for each pixel in the anchor image, its closest feature \hat{F}ᵢ from the features Fᵢ (in a geometric sense) as well as the corresponding forward consistency

$${\hat{C}}_{{I}_{i \to {I}_{A}}}$$

from the input image to the anchor image. Also, the two dimensional offsets resulting from the warping may be kept track of through the mapped coordinates \hat{F}ᵢ^{coord}. For every location in the input image, the real valued coordinates (x_{A}, y_{A}) in the anchor image and the mapping locations to the input image is stored.

At 406, the backward feature consistency

$${C}_{{I}_{A \to {I}_{i}}}$$

is computed for the warped coordinates \hat{F}ᵢ^{coord}. The backwards consistency is computed similarly to the forward consistency, but this time starting at coordinates (x_{A}, y_{A}) of the anchor image. The backward feature consistency

$${C}_{{I}_{A \to {I}_{i}}}$$

measures the consistency of the mappings from the anchor image p_{A}(x_{A}, y_{A}) to the input image p′(x,y) using mapping

$${M}_{{I}_{A \to {I}_{i}}}$$

and from the input image p′(x,y) to the anchor image p_{A}′(x′_{A}, y′_{A}) using mapping

$${M}_{{I}_{i \to {I}_{A}}} .$$

The consistency

$${C}_{{I}_{A \to {I}_{i}}}$$

is computed as e^{-|(x}^{_{A}}^{,y}^{_{A}}^{)-(x′}^{_{A}}^{,y′}^{_{A}}^{)|}, where “e” is an exponential function that may measure the difference between the forward projection and the backward projection locations. The estimation of the mappings (forward and backward) might contain errors. As a result, it would be good to be able to penalize the pixels (or patches) with imprecisions. The consistency maps provide information for the model to know how coherent the mappings are for a given pixel, which can then be used to influence the computation of the keys.

At 408, the absolute coordinates (x_{A}, y_{A}) are converted to relative coordinates (dx_{A}, dy_{A}) in mapped coordinates \hat{F}ᵢ^{offset}. The feature map \hat{F}, forward consistency map

$${\hat{C}}_{{I}_{i \to {I}_{A}}} ,$$

backward consistency map

$${\hat{C}}_{{I}_{A \to {I}_{i}}} ,$$

and mapped coordinates \hat{F}ᵢ^{offset} are combined (e.g., concatenated along the feature dimension). Then, a key prediction network 410-1 to generate keys and a value prediction network 410-2 to generate values receives the input to generate the keys and values, respectively. The keys may be included in a key map Kⁱ and the values are included in a value map Vⁱ for pixels of the anchor image. Key prediction network 410-1 is trained to generate key values based on the input and value prediction network 410-2 is trained to generate values based on the inputs.

### Multi-Frame Attention

FIG. 5 depicts an example of performing the multi-frame attention process according to some embodiments. After extracting the key-value pairs from each input image as discussed in FIG. 4, the key-value pairs in the resolution of the anchor image may be warped to the high resolution grid using mapping

$${M}_{{I}_{HR \to {I}_{A}}} 302$$

from the high resolution to the anchor image. Here, a grid sample 502 is performed to warp the key-value pairs K¹ . . . Kⁿ−V¹ . . . Vⁿ from every input image to every output pixel of the output image as \hat{K}¹ . . . \hat{K}ⁿ−\hat{V}¹ . . . \hat{V}ⁿ. This results in key-value pairs for pixels in the high resolution grid of the output image. If another characteristic is being resampled, then the key-value pairs may be warped to the other characteristic. Then, multi-frame attention system 312 is performed as discussed in FIG. 3 using query map 308. This results in a feature map 314 as discussed in FIG. 3. As discussed above, feature map 314 is computed by applying multi-headed attention to the key-value pairs using the query vectors extracted from the anchor image. Feature map 314 is then processed by prediction network 316 to generate the output image.

### Conclusion

Accordingly, a multi-frame resampling process can aggregate information from different input images in a flexible manner. This allows additional information that may be available to be used without restrictions. With the use of this additional information, the process produces improved output images. The flexibility is provided by using mappings between the high resolution grid and the anchor image, the input image to the anchor image, and the anchor image to the input image to allow different input images to be used. Multi-frame attention is used to generate a feature map from the input images and mappings. A prediction network that is trained to receive the feature map, mappings, and anchor image, and predict the output image, which allows the flexibility of using different input images.

### System

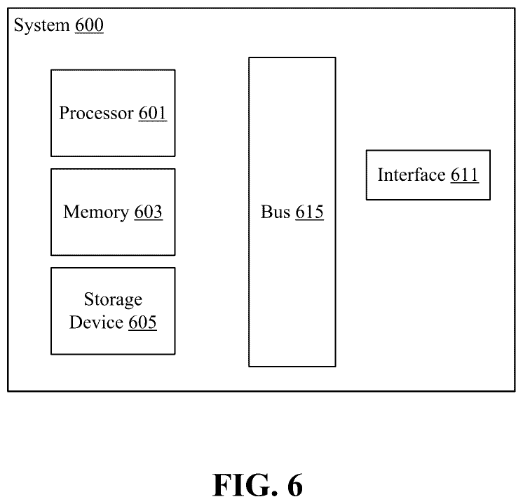

FIG. 6 illustrates one example of a computing device according to some embodiments. According to various embodiments, a system 600 suitable for implementing embodiments described herein includes a processor 601, a memory module 603, a storage device 605, an interface 611, and a bus 615 (e.g., a PCI bus or other interconnection fabric.) System 600 may operate as a variety of devices, or any other device or service described herein. Although a particular configuration is described, a variety of alternative configurations are possible. The processor 601 may perform operations such as those described herein. Instructions for performing such operations may be embodied in memory 603, on one or more non-transitory computer readable media, or on some other storage device. Various specially configured devices can also be used in place of or in addition to the processor 601. Memory 603 may be random access memory (RAM) or other dynamic storage devices. Storage device 605 may include a non-transitory computer-readable storage medium holding information, instructions, or some combination thereof, for example instructions that when executed by the processor 601, cause processor 601 to be configured or operable to perform one or more operations of a method as described herein. Bus 615 or other communication components may support communication of information within system 600. The interface 611 may be connected to bus 615 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a” “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
determining an anchor image and a first mapping of a grid to the anchor image, wherein the anchor image includes a first value of a characteristic and the grid includes a second value of the characteristic;
determining a set of input images and a set of second mappings between respective input images in the set of input images and the anchor image;
determining a query value for the grid based on features extracted from a location in the anchor image that is determined from the first mapping of the grid;
determining keys and values for each of the set of input images based on respective input images and respective second mappings;
weighting values of the set of input images based on comparing the query value and the respective keys to generate weighted values, wherein the weighted values are used to generate a feature value in a feature map; and
generating an output image from the feature map, wherein the output image is a resampling of the anchor image from the first value of the characteristic to the second value.

2. The method of claim 1, wherein:
the first value is a first resolution,
the second value is a second resolution, and
the second resolution is higher than the first resolution.

3. The method of claim 1 wherein the output image is a different size than the anchor image.

4. The method of claim 1, wherein input images in the set of input images include different values for the characteristic.

5. The method of claim 1, further comprising:
computing a feature value for each pixel of the output image in the feature map.

6. The method of claim 1, wherein weighting values of the set of input images comprises:
comparing the query value to at least a portion of the keys and values for input images in the set of input images;
weighting the values for the keys based on the comparing to generate the weighted values; and
generating the feature value in the feature map based on the weighted values.

7. The method of claim 6, wherein generating the feature value comprises:
combining the weighted values for the keys to generate the feature value.

8. The method of claim 1, wherein:
the keys and values are in a third value for an input image, and
the keys and values are mapped to the second value of the output image based on the first mapping of the grid.

9. The method of claim 1, wherein determining keys and values for each of the set of input images comprises:
extracting features from the input image;
determining a forward mapping consistency for pixels in the input image based on projecting pixels from a first location in the input image to a second location in the anchor image using the second mapping, and from the second location to a third location in the input image using the first mapping; and
aggregating the features and the forward mapping consistency in a coordinate grid of the anchor image using the first mapping.

10. The method of claim 9, further comprising:
determining a backward mapping consistency based on projecting pixels from the second location in the anchor image to a fourth location in the input image using the first mapping, and from the fourth location to a fifth location in the anchor image using the second mapping; and
using the features, the forward mapping consistency, and the backward mapping consistency to generate the keys and values for the input image.

11. The method of claim 10, wherein using the features, the forward mapping consistency, and the backward mapping consistency to generate the keys and values for the input image comprises:
inputting the features, the forward mapping consistency, and the backward mapping consistency input a first prediction network to generate the keys; and
inputting the features, forward mapping consistency, and the backward mapping consistency input a second prediction network to generate the values.

12. The method of claim 11, further comprising:
determining an offset from the anchor image and the input image for pixels; and
inputting the offset with inputting the features, the forward mapping consistency, and the backward mapping consistency into the first prediction network to generate the keys and into the second prediction network to generate the values.

13. The method of claim 10, wherein the forward mapping consistency is based on a difference between the first location and the third location.

14. The method of claim 10, wherein the backward mapping consistency is based on a difference between the second location and the fifth location.

15. The method of claim 1, wherein the first mapping of the grid is determined by mapping locations in the grid to pixels of the anchor image.

16. The method of claim 1, wherein the query value represents features extracted from the anchor image for a location in the grid.

17. A non-transitory computer-readable storage medium having stored thereon computer executable instructions, which when executed by a computing device, cause the computing device to be operable for:
determining an anchor image and a first mapping of a grid to the anchor image, wherein the anchor image includes a first value of a characteristic and the grid includes a second value of the characteristic;
determining a set of input images and a set of second mappings between respective input images in the set of input images and the anchor image;
determining a query value for the grid based on features extracted from a location in the anchor image that is determined from the first mapping of the grid;
determining keys and values for each of the set of input images based on respective input images and respective second mappings;
weighting values of the set of input images based on comparing the query value and the respective keys to generate weighted values, wherein the weighted values are used to generate a feature value in a feature map; and
generating an output image from the feature map, wherein the output image is a resampling of the anchor image from the second value of the characteristic to the first value.

18. The non-transitory computer-readable storage medium of claim 17, wherein weighting values of the set of input images comprises:
comparing the query value to at least a portion of the keys and values for input images in the set of input images;
weighting the values for the keys based on the comparing to generate the weighted values; and
generating the feature value in the feature map based on the weighted values.

19. The non-transitory computer-readable storage medium of claim 17, wherein input images in the set of input images are different sizes or resolutions.

20. An apparatus comprising:
one or more computer processors; and
a computer-readable storage medium comprising instructions for controlling the one or more computer processors to be operable for:
determining an anchor image and a first mapping of a grid to the anchor image, wherein the anchor image includes a first value of a characteristic and the grid includes a second value of the characteristic;
determining a set of input images and a set of second mappings between respective input images in the set of input images and the anchor image;
determining a query value for the grid based on features extracted from a location in the anchor image that is determined from the first mapping of the grid;
determining keys and values for each of the set of input images based on respective input images and respective second mappings;
weighting values of the set of input images based on comparing the query value and the respective keys to generate weighted values, wherein the weighted values are used to generate a feature value in a feature map; and
generating an output image from the feature map, wherein the output image is a resampling of the anchor image from the first value of the characteristic to the second value.
